(19) United States
(12) Patent Application Publication
(10) Pub. No.: US 2013/0073260 A1
(43) Pub. Date: Mar. 21, 2013

(54) METHOD FOR ANOMALY DETECTION/DIAGNOSIS, SYSTEM FOR ANOMALY DETECTION/DIAGNOSIS, AND PROGRAM FOR ANOMALY DETECTION/DIAGNOSIS

(71) Applicants: Shunji Maeda, Yokohama (JP); Hisae Shibuya, Chigasaki (JP); Hiroyuki Magara, Yokohama (JP)

(72) Inventors: Shunji Maeda, Yokohama (JP); Hisae Shibuya, Chigasaki (JP); Hiroyuki Magara, Yokohama (JP)

(21) Appl. No.: 13/641,886

(22) PCT Filed: Apr. 5, 2011
(86) PCT No.: PCT/JP2011/058582

§ 371 Date: Dec. 4, 2012

(30) Foreign Application Priority Data
Apr. 20, 2010 (JP) 2010-096873

(51) Int. Cl. G06F 15/00

(52) U.S. Cl. CPC G06F 15/00
USPC 702/183

(57) ABSTRACT

In order to provide a method and system for anomaly detection/diagnosis that can detect anomalies quickly and with high sensitivity in a machinery such as a plant, in the present disclosures, sets of maintenance record information comprising operational records, replacement part information and other past cases are associated with each other on a keyword basis, anomalies are detected on the basis of anomaly detection that targets the output signal of a multidimensional sensor attached to the machinery, and by means of connecting the detected anomaly with the associated maintenance record information, the required diagnosis/measures with respect to the anomaly that has arisen are elucidated.

### TECHNICAL FIELD

The present invention relates to a method for anomaly detection/diagnosis, a system for anomaly detection/diagnosis, and a program for anomaly detection/diagnosis in which an anomaly of a plant or machinery is quickly detected to make a diagnosis.

### BACKGROUND ART

Electric power companies supply warm water for regional heating systems using waste heat of gas turbines or supply high- or low-pressure steam to factories. Petrochemical companies operate gas turbines as power source machineries. In various plants and machineries using the gas turbines as described above, it is highly important to quickly find an anomaly to diagnose the cause and to take countermeasures because damage to society can be minimized.

Other than the gas turbines and steam turbines, there are too many machineries for which anomalies, including deterioration/lifetime of batteries mounted even in devices or parts, need to be quickly detected to make a diagnosis, such as water turbines in hydraulic power plants, nuclear reactors in nuclear power plants, wind turbines in wind power plants, engines of airplanes and heavy machines, railroad vehicles and rail tracks, escalators, elevators, medical equipment such as MRI, and manufacturing/inspection devices for semiconductor and flat-panel displays. In recent years, it is becoming important to detect anomalies (various symptoms) of human bodies as in an electroencephalographic measurement/diagnosis for health maintenance.

Therefore, for example, Patent Literature 1 and Patent Literature 2 describe that anomaly detection is performed mainly for engines. In each method, past data is kept as a database (DB), similarity between observed data and past learning data is calculated by a unique method, an estimate value is calculated by linear combination of data that is high in similarity, and a misfit degree between the estimate value and the observed data is output. Patent Literature 3 of General Electric Company describes an example of detecting an anomaly by k-means clustering.

Further, Non-patent Literature 2 and Patent Literature 4 describe that a breakdown record and an operation record are accumulated in a searchable database through which a useful finding related to maintenance is obtained.

### CITATION LIST

### Patent Literature

Patent Literature 1: U.S. Pat. No. 6,952,662
Patent Literature 2: U.S. Pat. No. 6,975,962
Patent Literature 3: U.S. Pat. No. 6,216,066
Patent Literature 4: Japanese Patent Application Laid-Open Publication No. 2009-110066

### Non-Patent Literature

Non-patent Literature 1: Stephan W. Wegerich; Nonparametric modeling of vibration signal features for equipment health monitoring, Aerospace Conference, 2003. Proceedings. 2003 IEEE, Volume 7, Issue, 2003 Page(s): 3113-3121
Non-patent Literature 2: Kazutoshi NAGANO, Jun SATO; Remote maintenance solution “TMSTATION” supporting accurate and quick response, Technical news from Toshiba Solutions Corporation, 2008, Autumn issue, Vol. 15

### SUMMARY OF THE INVENTION

### Technical Problem

In general, a system that detects an anomaly by monitoring observed data to be compared with a set threshold value is used in many cases. In this case, the threshold value is set by focusing on the physical quantity of a measurement target as each observed data, and thus the method is regarded as design-based anomaly detection.

In this method, it is difficult to detect an anomaly that is not intended in designing, and there is a possibility to overlook the anomaly. For example, the set threshold value is not considered to be appropriate due to working environments of machineries, state changes associated with working years, operation conditions, and effects of part replacement.

On the other hand, in the methods on the basis of case-based anomaly detection disclosed in Patent Literature 1 and 2, learning data that is high in similarity with observed data is linearly combined to calculate an estimate value, and a misfit degree between the estimate value and the observed data is output, so that working environments of machineries, state changes associated with working years, operation conditions, and effects of part replacement can be considered depending on preparation of the learning data.

However, in the methods disclosed in Patent Literature 1 and 2, data is handled as a snapshot, and temporal behavior is not considered. Further, it is necessary to additionally explain why an anomaly is contained in observed data. It is more difficult to explain an anomaly in the anomaly detection in a feature space whose physical meaning is vague, such as k-means clustering described in Patent Literature 3. In the case where an explanation is difficult, the detection is handled as wrong detection.

Further, the method described in Patent Literature 4 establishes a system (system that displays a maintenance chart according to Patent Literature 4) in which a breakdown record and an operation record are accumulated in a searchable database through which a useful finding related to maintenance is obtained. In this case, pieces of information related to the breakdown record and the operation record can be connected to each other through searching, and the information can be visually provided.

However, the connection between the anomaly detection and the information is unclear, and it is not always true that maintenance information stored in the system can be effectively utilized. The breakdown record and the operation record cannot be necessarily connected to each other by a simple search function. In such maintenance information, diverse pieces of information are generally dispersed, or the maintenance information is a list of ambiguous terms in many cases. Thus, if a keyword as an important factor in searching is not innovatively used, it is difficult to successfully hit. Specifically, in a method dependent only on a search, it is impossible to clarify “what past information was investigated to find the cause?”, “what countermeasure was taken?”, and “what should be done at this time?” on the basis of the detected anomaly as well as a sign of an anomaly. In addition, even in the case where a diagnosis should be quickly made at the stage of anomaly detection, a phenomenon, a cause, and a part to be replaced remain unclear and a measure to be taken is unknown. Thus, anomaly detection is, in reality, dependent on the investigation in the field by skilled maintenance workers.

Accordingly, an object of the present invention is to provide a method and a system for anomaly detection/diagnosis in which a new anomaly (including a sign) that has occurred can be accurately diagnosed using anomaly detection information targeting sensing data and maintenance record information composed of past cases such as an operation record and replacement part information.

Further, another object of the present invention is to provide a diagnosis process that can be presented even to beginners.

### Solution to Problem

In order to achieve the above-described objects, the present invention clarifies a diagnosis and a measure to be performed for an anomaly that has occurred in such a manner that pieces of maintenance record information composed of past cases such as an operation record and replacement part information are associated with each other on a keyword basis, an anomaly is detected on the basis of anomaly detection targeting an output signal of a multidimensional sensor attached to a machinery, and the detected anomaly and the associated maintenance record information are connected to each other.

Especially, in order to express the conditions (hereinafter, also refer to as context) where the maintenance record information was used, the frequency of appearance of a keyword is handled as a context pattern. Specifically, context considering the actually-used conditions is obtained as a frequency pattern, to be described later, from principal keywords representing operations related to maintenance including anomaly detection, and a context-oriented anomaly diagnosis using the context is realized.

Specifically, in the anomaly detection, (1) generation of (nearly) normal learning data, (2) calculation of the anomaly measurement of observed data by a subspace method or the like, (3) anomaly determination, (4) specifying of the type of anomaly, and (5) estimation of occurrence time of the anomaly are performed. In the association of the pieces of maintenance record information, through (6) keyword extraction of a document group such as a maintenance record and (7) classification of an image, (8) association of the keyword is performed, a diagnosis model is generated to express (9) the association between the anomaly and the keyword as a frequency pattern, and a diagnosis and a measure to be performed for the anomaly that has occurred is clarified using (10) the diagnosis model.

Further, in order to achieve the above-described objects, the present invention provides a method for anomaly detection/diagnosis that detects an anomaly of a plant or a machinery, or a sign of an anomaly to diagnose the plant or the machinery, the method comprising the steps of detecting an anomaly of the plant or the machinery by using data obtained from plural sensors; extracting a keyword from maintenance record information of the plant or the machinery; generating a diagnosis model of the plant or the machinery by using the extracted keyword; and diagnosing the plant or the machinery by using the generated diagnosis model.

In addition, the maintenance record information includes any of on-call data, an operational report, an adjustment/replacement part code, image information, and sound information; the frequency of appearance of the keyword set on the basis of the maintenance record information is calculated to obtain the pattern of the frequency of appearance; the obtained pattern of the frequency of appearance is used as the diagnosis model; and the plant or the machinery is diagnosed using similarity between the pattern of the frequency of appearance of the diagnosis model and a keyword related to a newly-detected anomaly of the plant or the machinery.

Further, in order to achieve the above-described objects, the present invention provides a system for anomaly detection/diagnosis that detects an anomaly of a plant or a machinery, or a sign of an anomaly to diagnose the plant or the machinery, the system including: an anomaly detecting unit that detects an anomaly of the plant or the machinery using data obtained from plural sensors; a database unit that accumulates maintenance record information of the plant or the machinery; a diagnosis model generating unit that generates a diagnosis model of the plant or the machinery using a keyword extracted from the maintenance record information of the plant or the machinery accumulated in the database unit; and a diagnosing unit that diagnoses the plant or the machinery by checking a newly-detected anomaly against the diagnosis model.

In addition, the maintenance record information accumulated in the database unit includes any of on-call data, an operational report, an adjustment/replacement part code, image information, and sound information; the diagnosis model generating unit calculates the frequency of appearance of the keyword set on the basis of the maintenance record information to obtain the pattern of the frequency of appearance, and uses the same as the diagnosis model; and the diagnosing unit diagnoses the machinery using similarity of the pattern of the frequency of appearance for a newly-detected anomaly.

Furthermore, in order to achieve the above-described objects, the present invention provides a program for anomaly detection/diagnosis that quickly detects an anomaly of a plant or an a machinery, or a sign of an anomaly to make a diagnosis, the program including: a processing step of detecting an anomaly using data obtained from plural sensors; a processing step of generating a diagnosis model using the frequency of appearance of a keyword obtained from maintenance record information; and a diagnosis processing step of diagnosing the plant or the machinery using the diagnosis model generated in the processing step of generating the diagnosis model.

In addition, an anomaly is detected using the data obtained from the plural sensors in the processing step of detecting the anomaly; the diagnosis model is generated using the frequency of appearance of the keyword obtained from the maintenance record information in the processing step of generating the diagnosis model; a pattern or a keyword is extracted through anomaly detection or a phenomenon diagnosis when the machinery is diagnosed using the diagnosis model generated in the diagnosis processing step; and the extracted pattern or keyword is used for a diagnosis.

Further, in order to achieve the above-described objects, the present invention provides a system for corporate asset management/machinery asset management including: a database that stores maintenance record information composed of an operational report, replacement part information, and the like; detecting means that allows a classifier such as a subspace method to detect an anomaly or a sign of an anomaly using signal information obtained from a multidimensional sensor attached to the machinery; and diagnosing means that makes a diagnosis on the basis of the frequency pattern of a keyword focusing on a replacement part or an adjustment, wherein the system performs anomaly/sign detection and a diagnosis triggered by the anomaly/sign detection.

### Advantageous Effects of Invention

According to the present invention, enormous amounts of maintenance record information existing in the field can be organized while being associated with anomalies, and a response to an anomaly that has occurred or a sign can be quickly determined. The conditions where the maintenance record information was used can be accurately expressed as a context pattern, and the context pattern can be verified. Thus, accumulated maintenance record information can be reused.

Anomalies, including deterioration/lifetime of batteries mounted even in devices or parts, can be quickly found with a high degree of accuracy and a diagnosis and a measure to be performed can be clarified by the above-described aspects of the present invention in various machineries and parts such as water turbines in hydraulic power plants, nuclear reactors in nuclear power plants, wind turbines in wind power plants, engines of airplanes and heavy machines, railroad vehicles and rail tracks, escalators, and elevators, other than gas turbines and steam turbines. It is obvious that the present invention can be applied to a case in which a human body is measured and diagnosed.

### BRIEF DESCRIPTION OF DRAWINGS

FIG. 1 is a block diagram for showing an example of machineries, multidimensional time-series signals, and event signals targeted by an anomaly detection system of the present invention.

FIG. 2 is a graph of signal waveforms for showing an example of the multidimensional time-series signals.

FIG. 3A is a block diagram for showing an example of detailed information of a maintenance record.

FIG. 3B is a block diagram for showing an example of association among phenomena, causes, and measures.

FIG. 4A shows an embodiment of the present invention and an example in which pieces of maintenance record information composed of past cases such as an operation record and replacement part information are associated with each other on a keyword basis, an anomaly is detected on the basis of anomaly detection targeting an output signal of a multidimensional sensor attached to a machinery, and the detected anomaly and the associated maintenance record information are connected to each other.

FIG. 4B shows the embodiment of the present invention and is a block diagram for showing an example in which the maintenance record information is used, and the frequency of appearance of a keyword is handled as a context pattern in order to express recorded conditions (context).

FIG. 5 is a table for showing an example of alarm activation and the presence or absence of on-site investigation, and reset, an adjustment, part replacement, and a take-home investigation as content of measures.

FIG. 6 is a bill of materials and a table for showing an example of a unit, a part number, and a part name.

FIG. 7A is a correspondence table between phenomena and adjustment/replacement parts and is a table for showing frequency on the basis of connection.

FIG. 7B is a correspondence table between phenomena and adjustment/replacement parts and is a graph for showing frequency on the basis of connection.

FIG. 8 is a block diagram for showing a configuration of the anomaly detection system of the present invention.

FIG. 9 is a block diagram for explaining a case-based anomaly detection method using plural classifiers.

FIG. 10A is a diagram for explaining a projection distance method of a subspace method as an example of the classifier.

FIG. 10B is a diagram for explaining a local subspace classifier of the subspace method as an example of the classifier.

FIG. 11A is a diagram for explaining selection of learning data by the subspace method.

FIG. 11B is a graph for showing the frequency distribution of distances of the learning data viewed from observed data.

FIG. 12 is a table for explaining a list of various feature conversions.

FIG. 13 is a diagram of a three-dimensional space for explaining the trajectories of residual vectors calculated by the subspace method.

FIG. 14 is a block diagram for showing a configuration of the periphery of a processor that executes the present invention.

FIG. 15A is a block diagram for showing the entire configuration of the present invention.

FIG. 15B is a block diagram for showing a configuration of the processor of the system for anomaly detection/diagnosis of the present invention.

FIG. 16 is a diagram for showing a network relation between sensor signals.

FIG. 17 is a flow diagram for showing details of the maintenance record information of the present invention and association of the maintenance record information.

### DESCRIPTION OF EMBODIMENTS

The present invention relates to a system for anomaly detection/diagnosis that quickly detects an anomaly of a plant or machinery, or a sign of an anomaly to make a diagnosis. When anomaly detection is performed, nearly normal learning data is generated, the anomaly measurement of observed data is calculated by a subspace method or the like to determine the anomaly, the type of anomaly is specified, and the occurrence time of the anomaly is estimated.

Further, when pieces of maintenance record information are associated with each other, a keyword of a document group such as a maintenance record is extracted and an image is classified, so that the keyword is associated.

In addition, a diagnosis model is generated to express the association between the anomaly and the keyword as a frequency pattern, and a diagnosis and a measure to be performed for the anomaly that has occurred are clarified using the diagnosis model.

Hereinafter, an embodiment of the present invention will be described with reference to the drawings.

### Embodiment

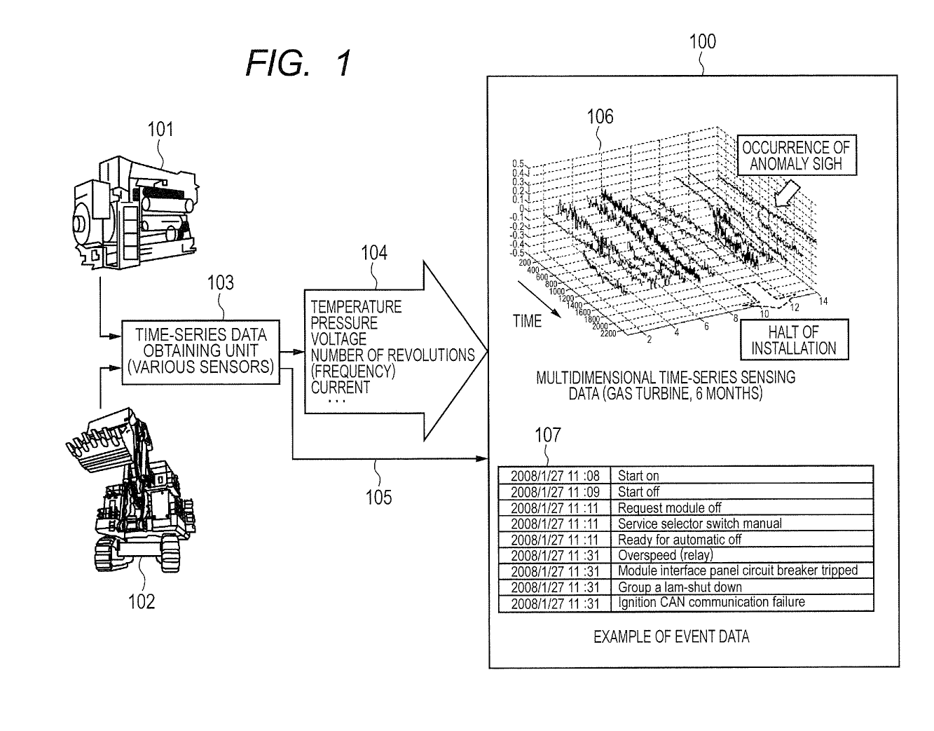

FIG. 1 shows an entire configuration including a system for anomaly detection/diagnosis 100 of the present invention. The reference numerals 101 and 102 denote machineries that are targeted by the system for anomaly detection/diagnosis 100 of the present invention, and each of the machineries 101 and 102 is provided with a multidimensional time-series signal obtaining unit 103 configured using various sensors. A sensor signal 104 obtained by the multidimensional time-series signal obtaining unit 103 and an event signal 105 representing an alarm and on/off of a power source are input to the system for anomaly detection/diagnosis 100 of the present invention to be processed. The system for anomaly detection/diagnosis 100 of the present invention obtains multidimensional time-series sensing data 106 and an event signal 107 from the sensor signal 104 obtained by the multidimensional time-series signal obtaining unit 103, and processes the data to perform anomaly detection/diagnosis for the machineries 101 and 102. There are several tens to several tens of thousands of types of sensor signals 104 obtained by the multidimensional time-series signal obtaining unit 103. The type of sensor signal 104 obtained by the multidimensional time-series signal obtaining unit 103 is determined in consideration of the sizes of the machineries 101 and 102 and various costs incurred by damage to society when the machineries are broken.

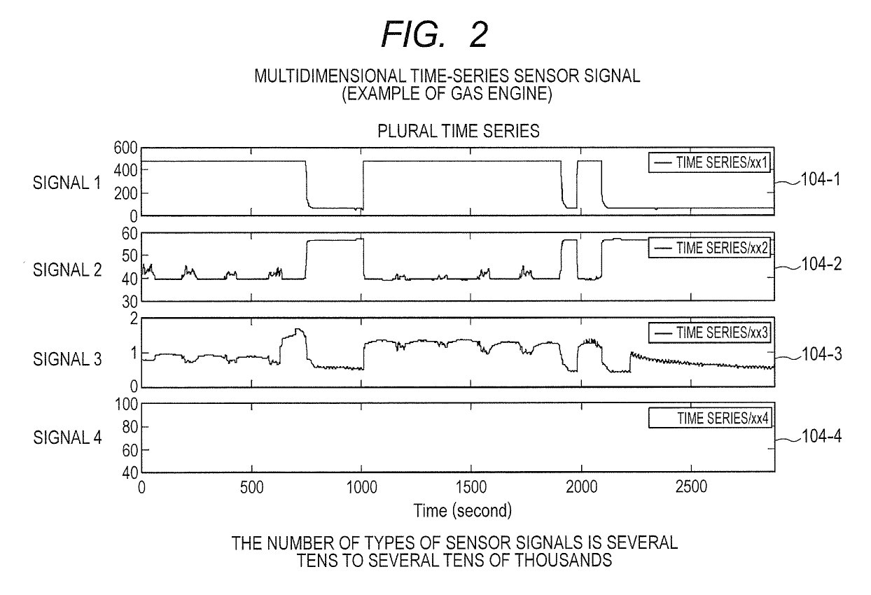

The target handled by the system for anomaly detection/diagnosis 100 is the multidimensional time-series sensor signal 104 obtained by the multidimensional time-series signal obtaining unit 103, and includes power generation voltage, an exhaust gas temperature, a cooling water temperature, a cooling water pressure, and operation time. Machinery environments and the like are monitored. The sampling timing of the sensor ranges from several tens of milliseconds to several tens of seconds. The event signal 104 and the event data 105 include an operation state, breakdown information, and maintenance information of the machineries 101 and 102. FIG. 2 is a diagram of the sensor signals 104-1 to 104-4 in which the horizontal axis represents time.

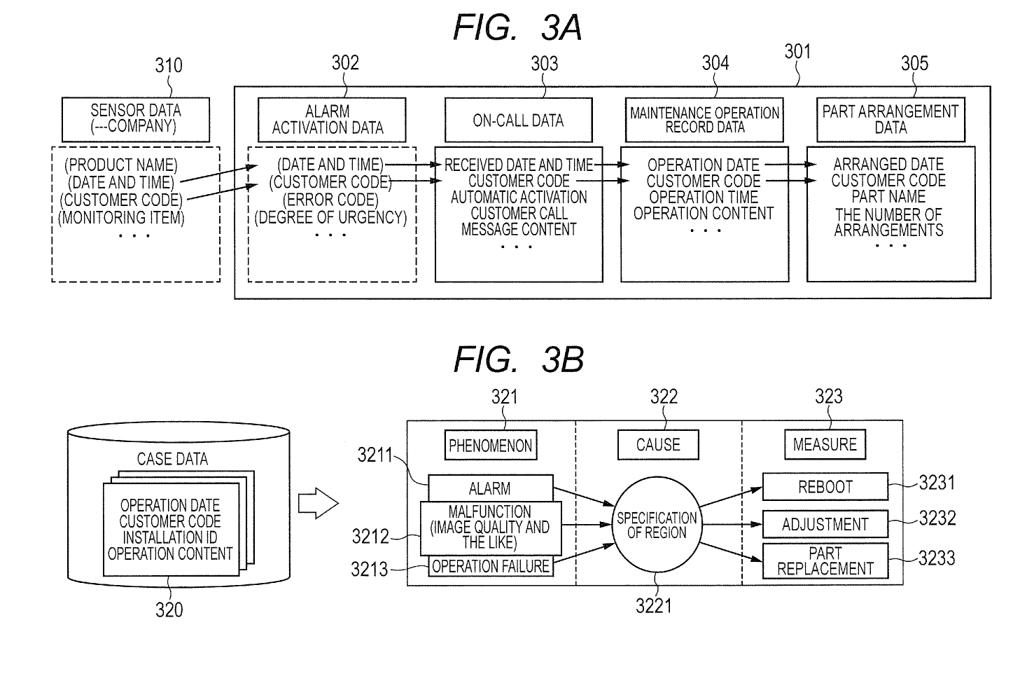

FIG. 3A shows details 301 of maintenance record information of the system for anomaly detection/diagnosis 100, and alarm activation 302, on-call data 303, maintenance operation record data 304, and part arrangement data 305 are associated with the maintenance record information in response to sensor data 310. In FIG. 3A, the on-call data 303 represents phone communication data. These pieces of information are stored in a database (DB) (121 of FIG. 14).

The arrows of FIG. 3A represent links of information from the upstream side to the downstream side. These arrows can be followed from the downstream side. In this case, a search based on a keyword is used. The search is a useful method. However, the database (DB) needs to have a searchable structure. Further, it is necessary to devise a way of determining a keyword, and flexibility to absorb a hierarchical relationship between regions and a hierarchical relationship between phenomena is required. However, the search itself is a simple verification, and thus can be easily used.

FIG. 3B is a diagram for showing association of the maintenance record information, and operation keywords such as a phenomenon 321, a cause 322, and a measure 323 searched from case data 320 stored in the database (DB) (121 of FIG. 14) are shown. The phenomenon 321 represents an alarm 3211, a malfunction (image quality and the like) 3212, an operation failure 3213, or the like, and is classified into more details. The cause 322 represents specification 3221 of a broken region. The measure 323 represents rebooting (not completely repaired) 3231, an adjustment 3232, and part replacement 3233. In the case of the drawing, the relationship can be expressed using arrows.

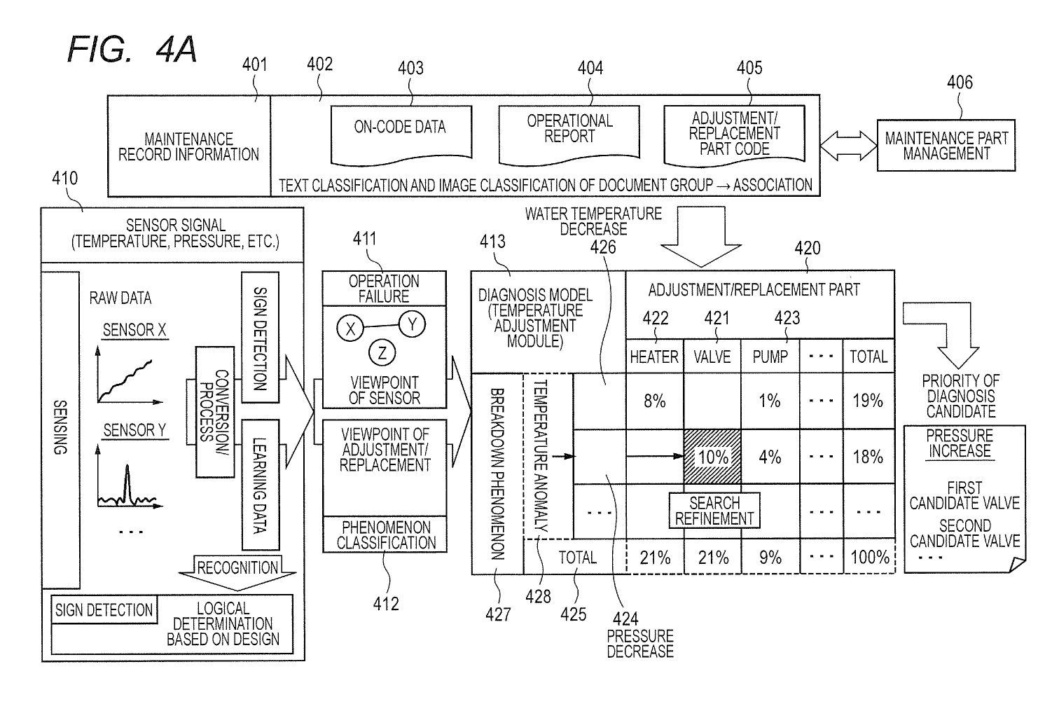

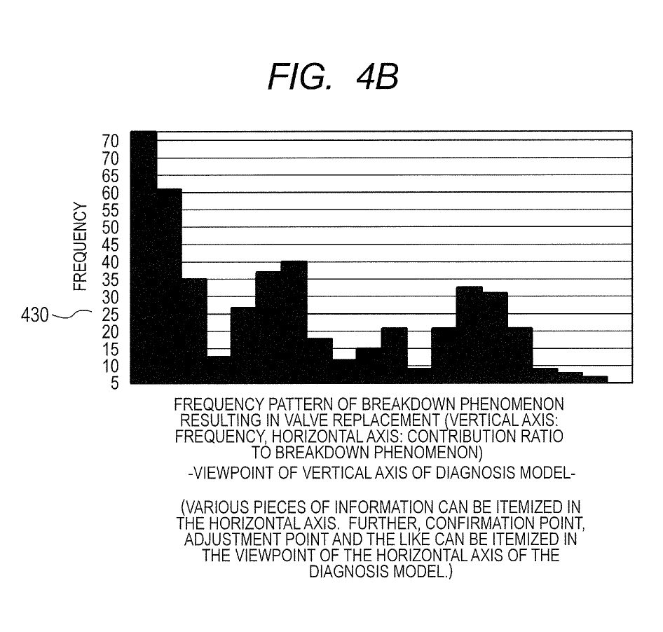

FIG. 4A shows an embodiment of the system for anomaly detection/diagnosis 100 according to the present invention.

FIG. 4A shows an example in which pieces of maintenance record information composed of past cases such as an operation record and replacement part information are associated with each other on a keyword basis, an anomaly is detected on the basis of anomaly detection targeting an output signal of the multidimensional sensor attached to the machinery, and the detected anomaly is connected to the associated maintenance record information. In order to use the maintenance record information and to express recorded conditions (context), FIG. 4A shows an example in which the frequency of appearance of keywords is regarded and handled as context patterns.

In the embodiment, the concept of a bag-of-words method is used. The bag-of-words method is a method like bagging of features, and pieces of information (features) are handled with little regard to the order of occurrence and positional relations. In this case, the frequency of occurrence of keywords, codes and words and a histogram are generated using alarm activation, an operational report, and a replacement part code, and the distribution shape of the histogram is regarded as a feature to be classified into categories. This method is characterized in that plural pieces of information can be handled at the same time unlike the one-on-one search as described in Non-patent Literature 2. In addition, this method can be adapted to a free description, is easily adapted to changes such as addition or deletion of information, and is less affected by format changes of the operational report or the like. If plural measures are taken or wrong measures are included, this method is high in robustness because this method focuses on the distribution shape of the histogram. As similar to the above, the sensor signal is also classified into plural categories. The categories serve as keywords.

Such expressions represent the conditions where the maintenance was conducted and are referred to as “context”.

The context is as follows:

“Under what condition was the information available?”

“What were they supposed to solve by using the information?”

“What is the reason for having used the information?”

“What did they focus on?”

“What is the relation with other information?”

Such context is represented by the patterns of the frequency of appearance of keywords.

The embodiment will be described in detail using FIG. 4A. A case of part replacement will be described. In FIG. 4A, record of replacement part 405 (corresponding to the part replacement 3233 of FIG. 3B) of maintenance record information 401 (corresponding to the case data 320 of FIG. 3B) is automatically accessed. For example, replacement of a valve will be described as an example. The name (part name) of the replacement valve, a part code (part number), and the date and time are used as keywords. As peripheral information of the maintenance record information, a bill of materials and the like are generally prepared. Thus, the bill of materials is accessed, and the name of a unit to which the replacement part belongs is added as a keyword. Next, an operational report 404 resulting in the replacement is accessed. The background where the part was replaced is described, and an alarm name, a phenomenon name, and check points and adjustment points described in measure content (rebooting, adjustment, and part replacement) are added as keywords.

The alarm name was activated by remote monitoring of the machinery. In FIG. 4A, the alarm name is information belonging to a sensor signal 410 shown on the left side. The alarm name indicates a name representing an anomaly such as a water pressure decrease, a pressure increase, the excessive number of revolutions, abnormal noise, or poor image quality. They are expressed using codes such as numbers. If the phenomenon is diagnosed on the remote monitoring side, the result of the phenomenon diagnosis executed in 411 is added to keywords. Here, the result of the phenomenon diagnosis represents the presence or absence of a correlation between monitored sensor signals and a phase relation. These are converted into keywords or quantified to be used as the results of the diagnoses. The target is not an anomaly, but is a sign of the anomaly in some cases.

For the plural keywords, namely, the code book, a histogram is aggregated in a table format 420 as shown in FIG. 4A. In the example of replacement of a valve, the frequency of appearance is increased in the section of a replaced valve 421 in the table. In the table format 420, the valve stands at 21% in the section of a total 425 described on the lower side. In the case where a heater 422 and a pump 423 other than the valve 421 are simultaneously replaced, each frequency of appearance thereof is accordingly increased. In addition, a pressure decrease is reported as the phenomenon diagnosis 411, and thus the frequency at the point (the part hatched in the table 420) at which the valve 421 and a pressure decrease 424 intersect with each other is increased in the table 420.

In FIG. 4A, each case is expressed by not frequency but a normalized percentage (%). However, frequency itself may be used. If the same cases resulting in replacement of a valve are aggregated, a more accurate table can be generated. As described above, a diagnosis model on which past cases are reflected can be completed. In the bag-of-words method, the frequency patterns are regarded as feature amounts. The frequency pattern in the section of the valve represents the frequency resulting in replacement of a valve for each phenomenon.

It should be noted that the keywords and the code book are provided by a designer or a maintenance worker, and are stored in the maintenance record information 401. However, weight may be given in consideration of importance. Weight may be given using a time relation between keywords such as early or late in terms of time, or the time relation may be a selection criterion.

Next, there will be described a case in which a new anomaly has occurs. The name of the anomaly was a pressure decrease. In this case, it can be found that the probability of valve replacement is 10%, and is higher than others in accordance with the diagnosis model. Thus, it is necessary first to confirm whether to replace the valve using the diagnosis model in the field. Obviously, the sensor signal may be analyzed in more detail to specify the broken region.

In the embodiment, the table 420 is more utilized. In general, a phenomenon is complicated. Even if the name of the anomaly is a pressure decrease, can be assumed that there are many cases in which parts other than a valve are replaced. Accordingly, while focusing on the frequency pattern (the frequency 430 of the water temperature decrease 426 and the pressure decrease 424 in the model 420 of FIG. 4A) representing a breakdown phenomenon 427 (the frequency pattern 430 of the breakdown phenomenon resulting in valve replacement is generated for each phenomenon as shown in FIG. 4B, and the vertical axis represents frequency and the horizontal axis represents the type of breakdown phenomenon and a contribution ratio to the breakdown phenomenon), the frequency pattern 430 is regarded as a feature amount. The frequency pattern of the valve, namely, the valve 421 is selected to match the feature. It should be noted that a contribution ratio to the breakdown phenomenon is a divergence from the normal state of each sensor signal (104 of FIG. 2). Thus, it is necessary to recognize that data to be observed and diagnosed exhibits not frequency but a certain pattern at the time of starting the diagnosis. Obviously, not only the contribution ratio, but also information as the frequency of the contribution ratio that is temporal counting can be used at the time of starting the diagnosis.

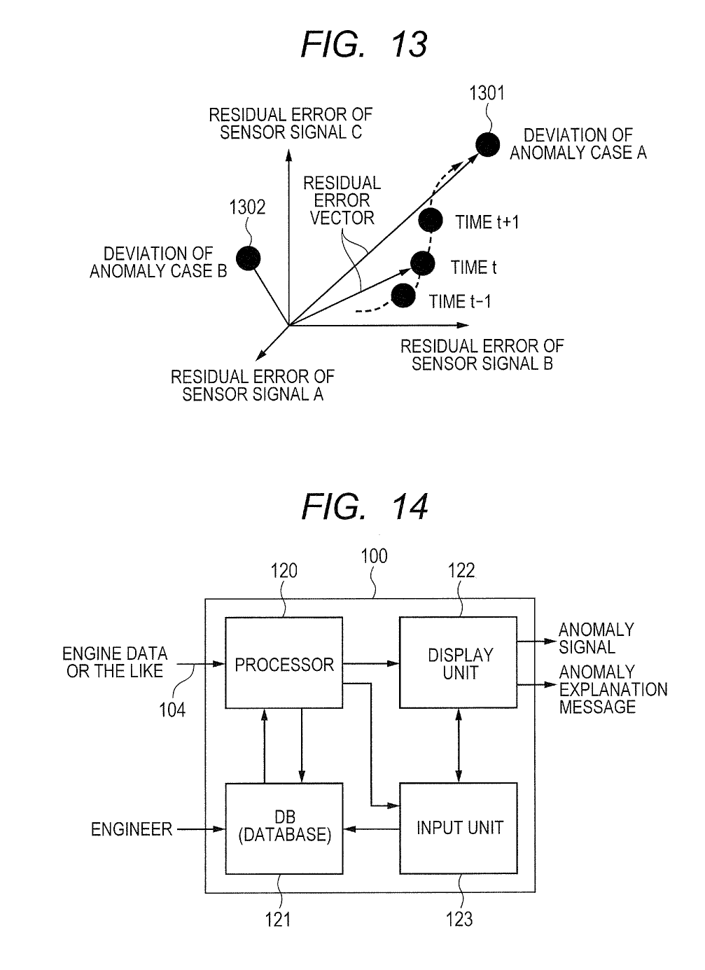

If focusing on time-series changes of residual vectors shown in FIG. 13, to be described later and the time-series changes are handled as the frequency of occurrence in a certain time window, they can be handled as frequency information and frequency patterns. In any case, the method based on the above-described frequency patterns is not a simple process such as the presence or absence, but is focused on the distribution patterns. Thus, the method is extremely high in flexibility and robustness as compared to the method based on a simple search.

As described above, if the diagnosis model is used, a diagnosis operation can be smoothly performed in the field and the operation time can be considerably shortened. Further, since a candidate for a replacement part can be prepared in advance, the time required to restore the machinery can be considerably shortened.

In the above-described example, the frequency patterns are used as the types of breakdown phenomena. However, usable information such as a check region, an adjustment point, information obtained by on-call, a replacement part, and a cause found after being taken home may be used. The bag-of-words method can be used because it focuses on the frequency. Further, if there are many items in the horizontal axis, it can be considered as a high dimension. Thus, it is effective to reduce the dimension. A general pattern recognition method such as a principal component analysis, an independent component analysis, or selection of feature amounts can be effectively used. A normalization method such as whitening can be also used.

In the system for anomaly detection/diagnosis of FIG. 4A, an example of replacement parts is shown as the viewpoint of classification. Other viewpoints of classification may be employed, and the table (diagnosis model) 420 in which the horizontal axis represents other definition categories such as check points of values and conditions and adjustment points such as setting dials of resistance values and setting time may be generated. Specifically, plural diagnosis models with plural divided sheets are used in accordance with an object, conditions, and a user. It should be noted that a pattern statistical method other than the bag-of-words method can be used.

The diagnosis model can be used as educational information for a beginner. Further, the method can be reflected on a maintenance operating procedure based on the diagnosis model.

In FIG. 4A, phenomenon classification 412 is also important. The phenomenon classification in this case means that keywords are defined for anomalies obtained from the sensor signals 410 in the viewpoint of measures such as adjustments and replacement. The defined keywords are added or amended to be used for a diagnosis model 413. Specifically, the keywords are added to anomalies or signs in accordance with the result of the phenomenon classification. If a water pressure is increased, adding a keyword of a water pressure increase is the simplest case. Further, in accordance with the classification based on a decision tree such as C4.5, keywords can be automatically added. Keywords are added in accordance with phenomena. However, keywords may be grouped or segmentalized at the time the type of adjustment or replacement is found, so that a new keyword is added. As described above, the phenomenon classification needs to be edited.

The maintenance record information 401 shown in FIG. 4A is referred to as EAM related to maintenance. In general, EAM stands for Enterprise Asset Management, and is also referred as corporate asset management/machinery asset management. EAM means business improvement solutions in which various information related to machinery assets owned by a company is centrally controlled throughout the lifecycle and the asset itself and related businesses are visualized, standardized, and made efficiency. FIG. 4A shows EAM specialized in maintenance. Such maintenance EAM includes anomaly sign detection, a diagnosis, and a maintenance part plan other than document management of the maintenance record information 401 and the like. It should be noted that the maintenance part plan realizes proper inventory management of maintenance parts in the case of conducting maintenance on the basis of the result of the diagnosis.

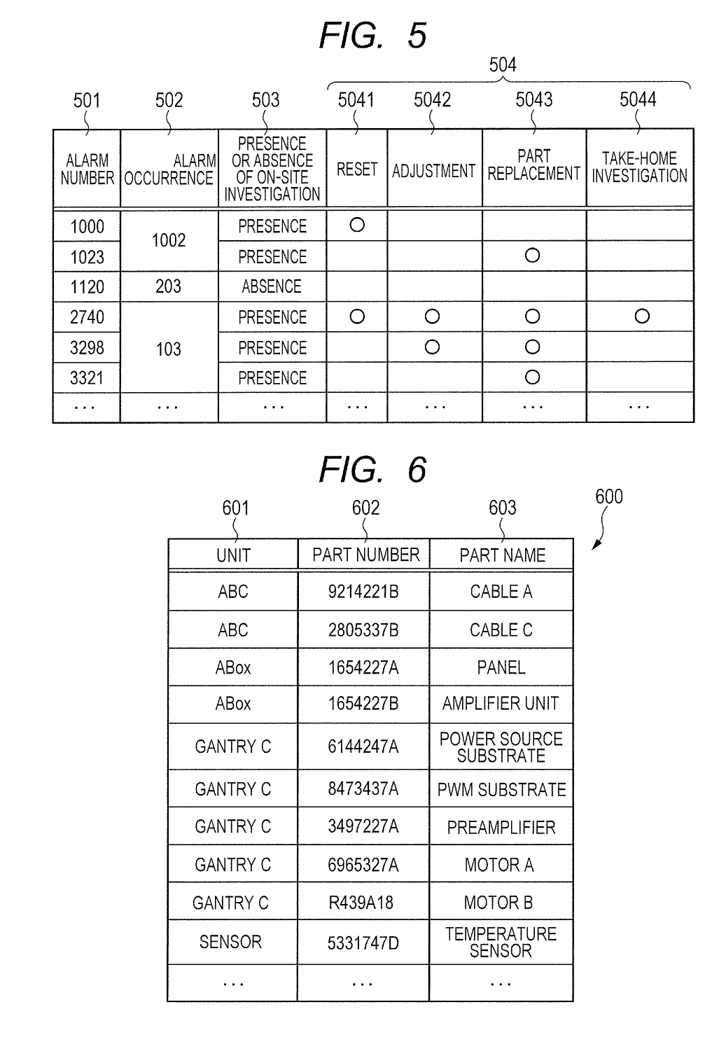

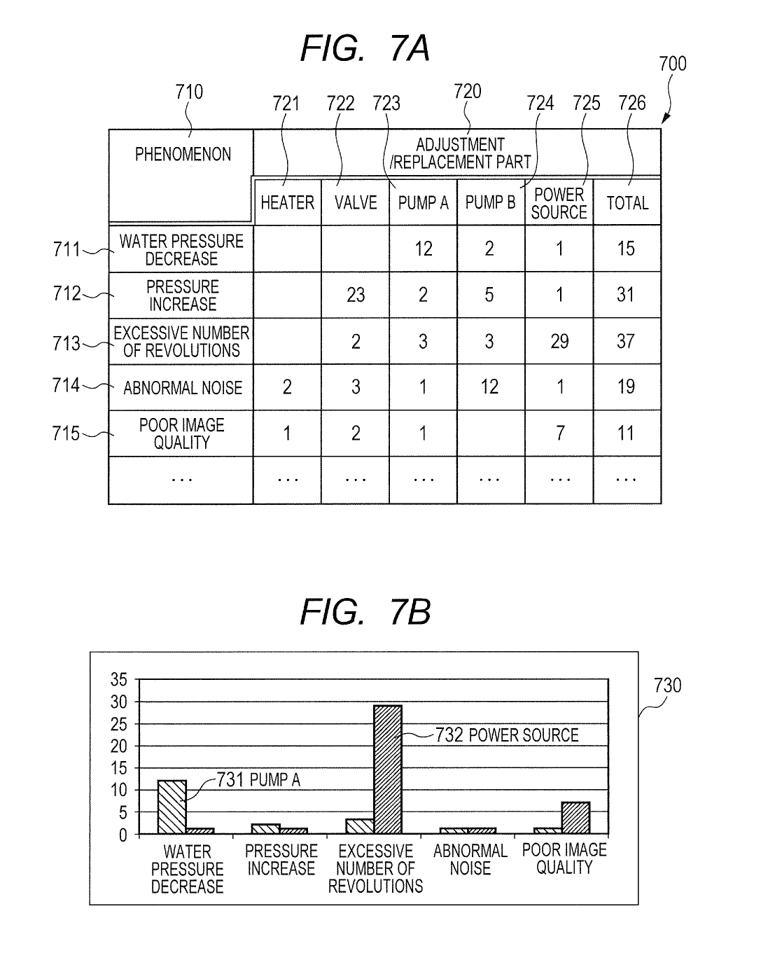

FIG. 5 shows alarm occurrence 502, the presence or absence of on-site investigation 503, and measure content 504 in each alarm number 501. The measure content 504 represents reset 5041, an adjustment 5042, part replacement 5043, and a take-home investigation 5044. FIG. 6 shows a bill of materials 600 in which a unit 601, a part number 602, and a part name 603 are shown as an example. FIG. 7A shows a correspondence table 700 between a phenomenon 710 and an adjustment/replacement part 720, and represents frequency on the basis of the connection. Keywords 721 to 725 described in the table are extracted and a total 726 of frequency is counted to be used to generate the diagnosis model. It should be noted that the phenomenon 710 includes a water pressure decrease 711, a pressure increase 712, the excessive number of revolutions 713, abnormal noise 714, poor image quality 715, and the like. These may be divided for each region of the machinery. Further, the poor image quality 715 is usually classified into more details for each machinery due to a malfunction.

FIG. 7B shows a frequency pattern 730 of each part corresponding to each phenomenon. The frequency of occurrence (in practice, the frequency of keywords described in the operational report may be used or keywords extracted on the basis of the result obtained by analyzing an image recorded by a camera or the like attached to a worker may be used) of phenomena generated when a pump A731 and a power source 732 are adjusted or replaced is aggregated. The frequency patterns are used as the feature amounts of the bag-of-words method. The adjustment and replacement may be separately or independently aggregated. Each item of the frequency pattern can be added or edited.

It should be noted that FIG. 7A shows the results obtained by aggregating the results of adjustment and replacement. However, phenomena occurring at the same time are regarded as a pair or two or more sets of groups using the notion of co-occurrence, and the group can be regarded as one phenomenon. This belongs to the phenomenon classification 412 described in FIG. 4A. It should be noted that the same time means phenomena that occur in a certain period of time, and the order of occurrence is considered or not considered in some cases. In the case where the order of occurrence is considered, causality is kept in mind.

Further, the items of the frequency patterns 730 in FIG. 7B include the number of inquiries from a maintenance worker to a maintenance center and the content of the inquiries (described using keywords).

The frequency patterns 730 of various keywords are regarded as “context” representing the conditions of the machinery, the conditions of occurrence of anomalies, the conditions of maintenance, the conditions resulting in part replacement, and past cases. It can be conceived in a way that a search can be performed while adding context and conditions to a search with a keyword alone. In other words, a format of “if then” was used in the past and the usage situation could not be searched at all. As a result, a diagnosis of or countermeasures against the “then” part ended up in vain in many cases. Such ineffective keyword expressions/usage situations are more flexibly expressed by the frequency patterns, and are regarded as a well-directed format. Accordingly, a highly-reliable diagnosis can be made as compared to the diagnosis/countermeasures on the basis of “if then”.

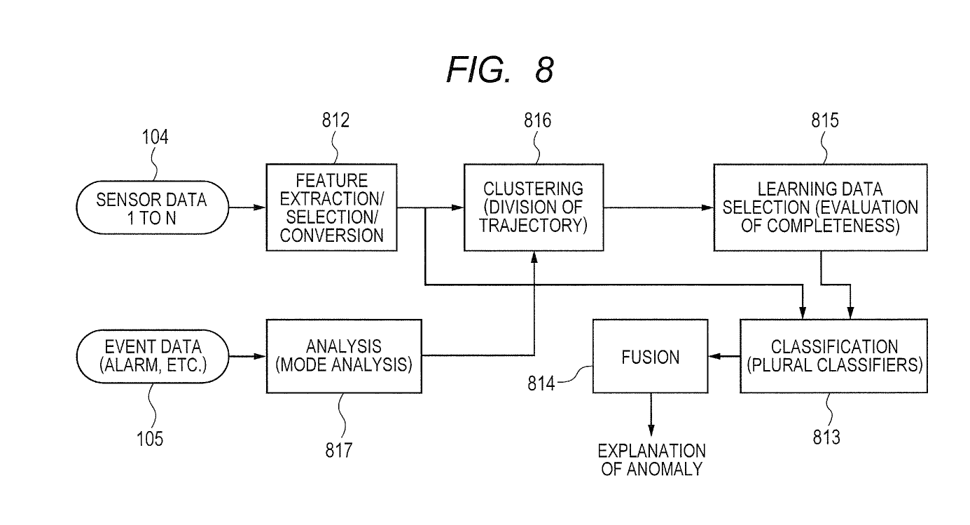

FIG. 8 shows a method of detecting anomalies in a case-based manner, and an example of a case-based anomaly detection/multivariate analysis in which multidimensional sensor signals are targeted. The sensor data 1 to N:104 obtained by the multidimensional time-series sensor signal obtaining unit 103 shown in FIG. 1 are received by the system for anomaly detection/diagnosis 100 of the present invention, and feature extraction/selection/conversion 812, clustering 816, and learning data selection 815 are performed. A multivariate analysis is performed for the multidimensional time-series sensor data 104 and observed sensor data as misfit values relative to normal data or the resultant value are output to a fusion unit 814 from a classifying unit 813. When anomalies or signs are detected by the fusion unit 814, the above-described diagnoses, namely, diagnoses such as verification operations between the contribution ratio to the breakdown phenomenon (not only the contribution ratio, but also patterns as frequency that is temporal counting) and frequency patterns on the basis of past cases are started.

In the clustering 816, the sensor data is divided into some categories in each mode in accordance with an operation state. By using event data (ON/OFF control of the machinery, various alarms, and regular inspection/adjustment of the machinery) other than the sensor data, learning data can be selected and an anomaly diagnosis can be made in some cases on the basis of the analysis result. Event data 811 can be divided into some categories in each mode on the basis of the event data 105 to be input to the clustering 816. The event data 105 is analyzed and interpreted by an analyzing unit 817.

Further, classification is performed using plural classifiers by the classifying unit 813, and the results are fused by the fusion unit 814, so that robust anomaly detection can be realized. An explanation message for the anomaly is output from the fusion unit 814.

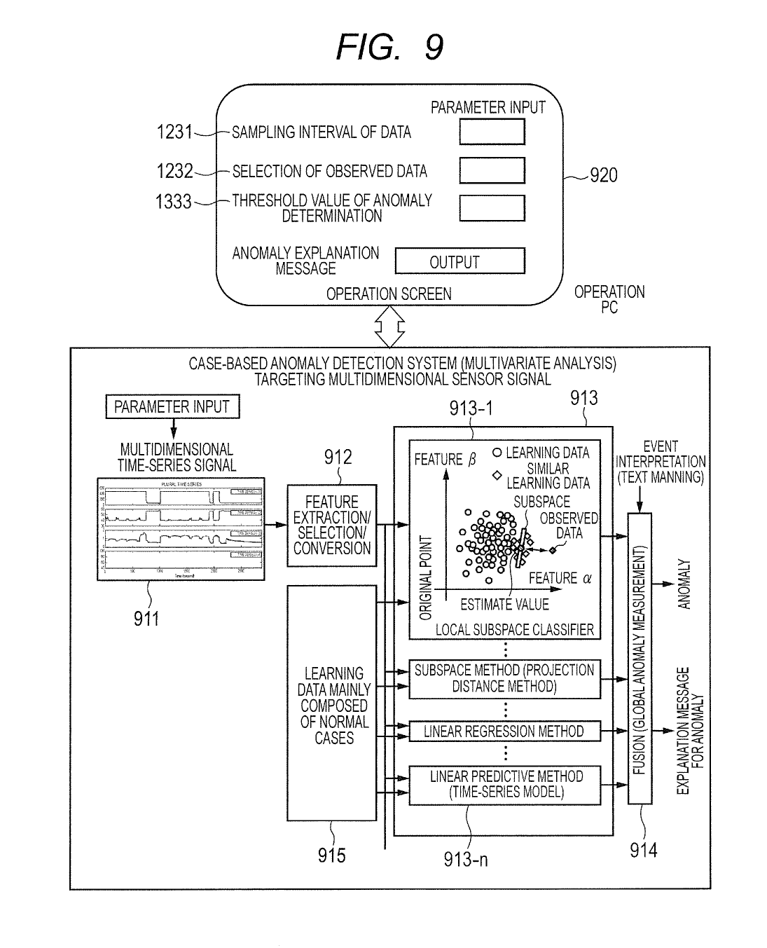

FIG. 9 shows an inner configuration of the system for anomaly detection/diagnosis 100 that performs a case-based anomaly detection process. In the anomaly detection, the reference numeral 912 denotes a feature extraction/selection/conversion unit that performs a process in response to a multidimensional time-series signal 911 based on the various sensor signals 104 obtained by the multidimensional time-series signal obtaining unit 103. The reference numeral 913 denotes a classifier; 914, a fusion processing unit (global anomaly measurement); and 915, a learning data storing unit mainly composed of normal cases.

The dimension of the multidimensional time-series signal input from the multidimensional time-series signal obtaining unit 911 is reduced by the feature extraction/selection/conversion unit 12, and the multidimensional time-series signal is classified by plural classifiers 913-1 to 913-n of the classifier 913. Then, the global anomaly measurement is determined by the fusion processing unit (global anomaly measurement) 914. The learning data mainly composed of normal cases stored in the learning data storing unit 915 is classified by the plural classifiers 913-1 to 913-n to be used for determination of the global anomaly measurement. In addition, the learning data itself mainly composed of normal cases stored in the learning data storing unit 915 is selected, and is accumulated and updated by the learning data storing unit 915 to improve the accuracy.

FIG. 9 illustrates a screen 920 displayed on an input unit 123 into which a user inputs parameters. The parameters input by the user from the input unit 123 are a data sampling interval 1231, observed data selection 1232, and an anomaly determination threshold value 1233. The data sampling interval 1231 is used to instruct, for example, how often data is obtained.

The observed data selection 1232 is used to instruct what sensor signal is mainly used. The anomaly determination threshold value 1233 is a threshold value to digitalize values of anomalies expressed as the calculated deviation/departure, misfit value, divergence degree, and anomaly measurement from the model.

The classifier 913 shown in FIG. 9 is provided with some classifiers (913-1 to 913-n), and these are decided (fused) by a majority by the fusion processing unit 914. Specifically, ensemble (group) learning using a different group of classifiers (913-1 to 913-n) can be applied. For example, the first classifier 913-1 can be applied to a projection distance method, the second classifier 913-2 can be applied to a local subspace classifier, and the third classifier 913-3 can be applied to a linear regression method. An arbitrary classifier can be applied if it is based on case data.

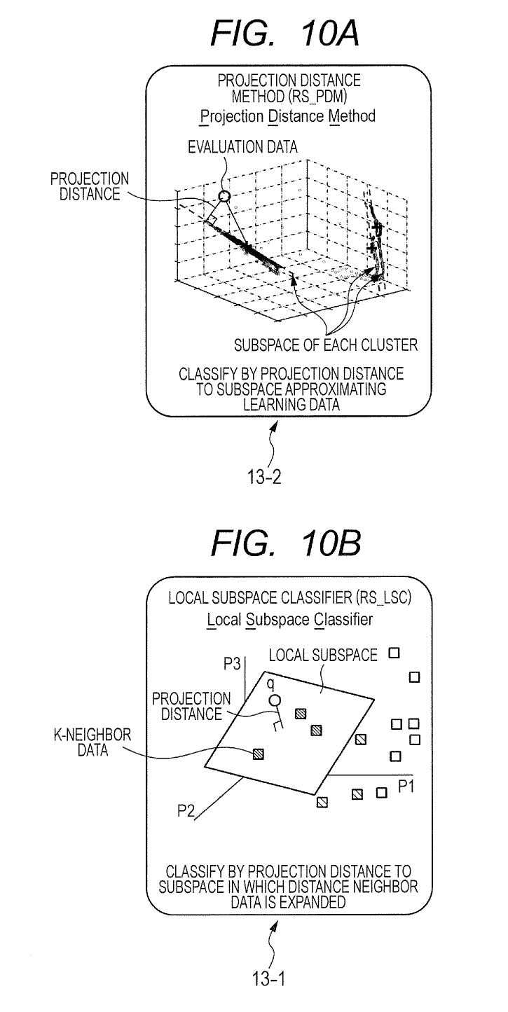

FIG. 10A and FIG. 10B show an example of a classifying method in the classifier 913. FIG. 10A shows the projection distance method. In the projection distance method, a deviation from a model is obtained. In general, eigenvalue decomposition is performed for the autocorrelation matrix of data of each class (category), and an eigenvector is obtained as a base. Eigenvectors corresponding to some of top larger eigenvalues are used.

When an unknown pattern q (latest observed pattern) is input, the length of orthogonal projection to a subspace, or a projection distance to a subspace is obtained. A normal part of the multidimensional time-series signal is basically targeted, and thus a distance from the unknown pattern q (latest observed pattern) to a normal class is obtained to be used as a deviation (residual error). If the deviation is large, it is determined as a misfit value.

Even if the anomaly values are slightly mixed in such a subspace method, the influence is eased at the time of reducing the dimension and forming the subspace. This is the merit obtained by applying the subspace method. A normal class is divided into plural classes in advance in consideration of the operation patterns of the machinery. In this case, event information may be used, or may be executed by the clustering processing unit 816 of FIG. 8.

It should be noted that the center of gravity of each class is used as an original point in the projection distance method. An eigenvector obtained by applying Karhunen-Loeve expansion to the covariance matrix of each class is used as a base. Various subspace methods have been proposed. If a distance measure is provided, a misfit degree can be calculated. It should be noted that in the case of density, the misfit degree can be determined on the basis of the magnitude of density. The projection distance method corresponds to a similarity measure because the length of orthogonal projection is obtained.

As described above, the distance and similarity are calculated in a subspace to evaluate a misfit degree. Since the subspace method such as the projection distance method is a classifier based on a distance, metric learning can be used to learn vector quantization and a distance function for updating dictionary patterns as a learning method when anomaly data can be used.

FIG. 10B shows another example of a classifying method in the classifier 913. This method is referred to as a local subspace classifier. K-pieces of multidimensional time-series signals near the unknown pattern q (latest observed pattern) are obtained, and a linear manifold is generated so that the nearest neighbor pattern of each class serves as an original point. In addition, the unknown pattern is classified into a class with the minimum projection distance to the linear manifold. The local subspace classifier is a type of subspace method. k is a parameter. In the anomaly detection, a distance from the unknown pattern q (latest observed pattern) to the normal class is obtained to be used as a deviation (residual error).

In this method, for example, a point obtained by orthogonal projection from the unknown pattern q (latest observed pattern) to a subspace formed using k-pieces of multidimensional time-series signals can be calculated as an estimate value.

Further, k-pieces of multidimensional time-series signals are rearranged in the order near the unknown pattern q (latest observed pattern), and the estimate value of each signal can be calculated by weighting in inverse proportion to the distance. In the projection distance method or the like, the estimate value can be similarly calculated.

One type of parameter k is generally set. However, if some parameters k are used for execution, target data is selected in accordance with similarity, and comprehensive determination can be more effectively made from these results.

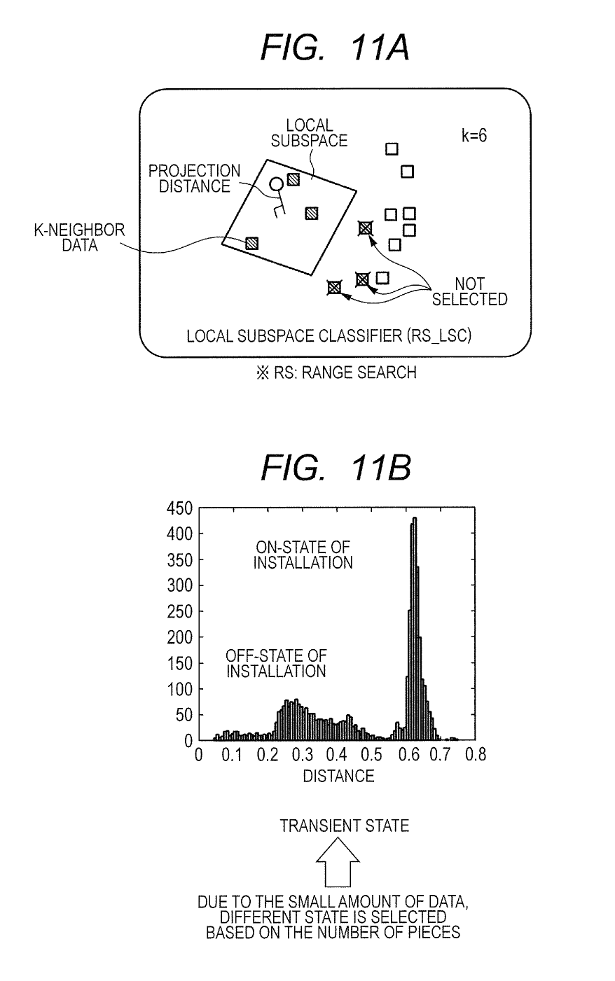

Further, as shown in FIG. 11A, in order to set an appropriate value of k for each observed data in the local subspace classifier, learning data with a distance within a predetermined range from the observed data is selected, and the number of pieces of learning data is sequentially increased from the minimum number to the selective number, so that learning data with the minimum projection distance may be selected.

This can be applied to the projection distance method. Detailed procedures are as follows:

1. Distances between observed data and learning data are calculated and rearranged in ascending order.
2. Learning data with a distance d<th and the number of pieces of which is k or smaller is selected.
3. A projection distance is calculated in a range of j=1 to k and the minimum value is output.

Here, the threshold value th is experimentally determined from the frequency distribution of distances. The distribution in FIG. 11B represents the frequency distribution of distances of the learning data viewed from the observed data. In accordance with ON/OFF of the machinery, the diphasic frequency distribution of distances of the learning data is shown in this example. The valley between two mountains represents a transition period from ON to Off or from OFF to ON of the machinery.

This concept is referred to as a range search, and it is assumed that the range search is applied to selection of learning data. The concept of selection of learning data in a range search method can be applied to the methods disclosed in Patent Literature 1 and 2. It should be noted that even if the anomaly values are slightly mixed in the local subspace classifier, the effects are considerably eased at the time of forming the local subspace.

It should be noted that although not shown in the drawing, the center of gravity of k-neighbor data is defined as a local subspace in classification called as an LAC (Local Average classifier) method. A distance from the unknown pattern q (latest observed pattern) to the center of gravity is obtained to be used as a deviation (residual error).

An example of the classifying method in the classifier 13 shown in FIG. 9 is provided as a program. It should be noted that if simply regarded as an issue of one class classification, a classifier such as a one class support vector machine can be applied. In this case, Radial Basis Function Kernel mapping to a high-dimensional space can be used.

In the one class support vector machine, values near the original point are misfit values, namely, anomalies. It should be noted that the support vector machine can be adapted to the high dimension of feature amounts. However, if the number of pieces of learning data is increased, the amount of calculations is disadvantageously enormously increased.

Therefore, a method such as “IS-2-10, Takekazu KATO, Mami NOGUCHI, Toshikazu WADA (Wakayama University), Kaoru SAKAI, Syunji MAEDA (Hitachi, Ltd.); one class classifier based on accessibility of patterns” presented in MIRU2007 (Meeting on Image Recognition and Understanding 2007) can be applied. In this case, if the number of pieces of learning data is increased, it is advantageous in that the amount of calculations is not enormously increased.

As described above, the multidimensional time-series signals are expressed with a low-dimensional model, so that a complicated state can de decomposed and can be expressed with a simple model. Accordingly, the phenomena can be advantageously easily understood. Further, since the model is set, it is not necessary to completely prepare data as methods disclosed in Patent Literature 1 and 2.

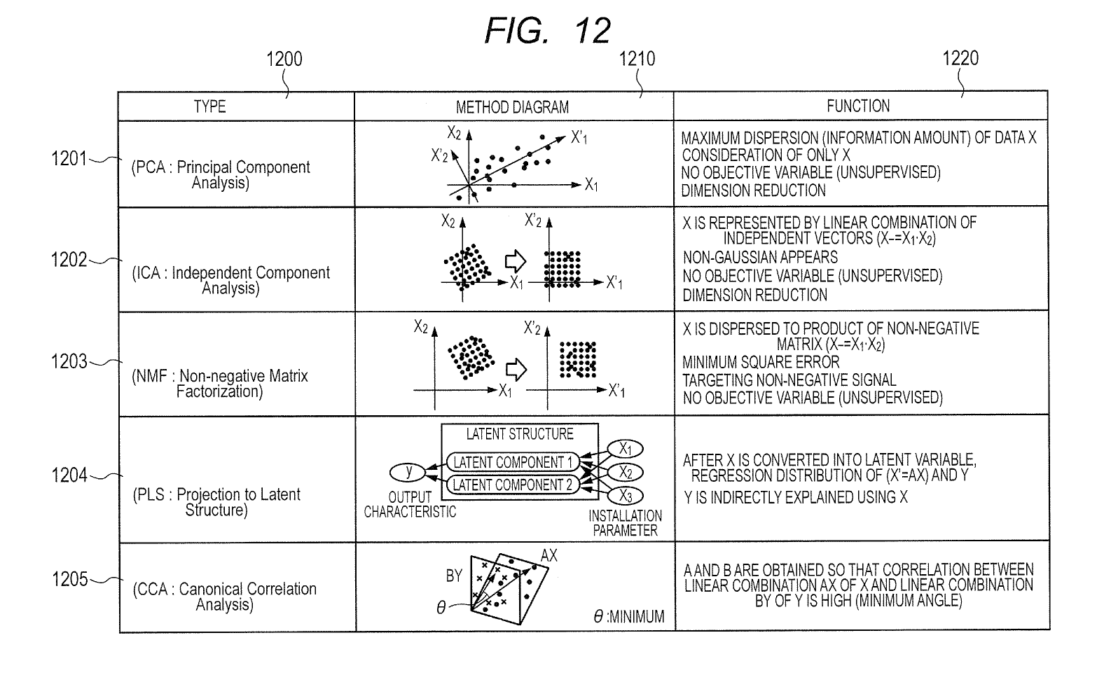

FIG. 12 shows an example of feature conversion 1200 in which the dimension of the sensor data 1 to N:104 as the multidimensional time-series signals obtained by the multidimensional time-series sensor signal obtaining unit 103 used in FIG. 8 is reduced. Other than a principal component analysis (PCA) 1201, some methods such as an independent component analysis (ICA) 1202, a non-negative matrix factorization (NMF) 1203, a projection to latent structure (PLS) 1204, and a canonical correlation analysis (CCA) 1205 can be applied. FIG. 12 shows a method diagram 1210 and a function 1220 together.

The principal component analysis 1201 is referred to as PCA, and M-dimensional multidimensional time-series signals are linearly converted into r-dimensional multidimensional time-series signals with the number of dimensions r to generate an axis with the maximum variation. Karhunen-Loeve conversion may be used. The number of dimensions r is determined on the basis of a value as a cumulative contribution ratio obtained in such a manner that eigenvalues obtained by the principal component analysis are arranged in descending order and the sum of some larger eigenvalues is divided by the sum of the all eigenvalues.

The independent component analysis 1202 is referred to as ICA, and is effective as a method of actualizing non-gaussian. The non-negative matrix factorization is referred to as NMF, and a sensor signal expressed in a matrix format is decomposed into non-negative components.

The methods with “unsupervised” in the section of the function 1220 are effective conversion methods in the case where the number of anomaly cases is small and the anomaly cases cannot be utilized as in the embodiment. In this case, an example of linear conversion is shown. However, non-linear conversion can be applied.

The above-described feature conversions, including the canonicalization for normalizing with the standard deviation, are simultaneously performed together with the learning data and the observed data. With this configuration, the learning data and the observed data can be handled in the same rank.

FIG. 13 is an explanatory view of a sign detection technique of anomaly occurrence by residual error patterns. FIG. 13 shows a method of calculating the similarity of residual error patterns. FIG. 13 is adapted to the normal center of gravity of each observed data obtained by the local subspace classifier and expresses a deviation from the normal center of gravity of each of a sensor signal A, a sensor signal B, and a sensor signal C at each point as a trajectory in a space. To be precise, each axis shows main principal components.

In FIG. 13, residual error series of the observed data passing through time t−1, time t, and time t+1 are represented by the dotted arrows. Each similarity of the observed data and anomaly cases can be estimated by calculating the inner product (A·B) of each deviation. Further, the similarity can be estimated with an angle θ by dividing the inner product (A·B) by the size (norm). The similarity is calculated for the residual error patterns of the observed data, and anomalies predicted to occur are estimated from the trajectory.

Specifically, FIG. 13 shows a deviation 1301 of an anomaly case A and a deviation 1302 of anomaly case B. With reference to the deviation series pattern of the observed data including the time t−1, time t, and time t+1 represented by the dotted arrow, the anomaly is near the anomaly case B at the time t. However, not the anomaly case B but the anomaly case A can be predicted to occur from the trajectory. If there is no corresponding anomaly in the past anomaly cases, it can be determined as a new anomaly. Further, the space shown in FIG. 13 is divided into conical intervals each vertex of which matches the original point, and anomalies can be identified using the intervals.

In order to predict the anomaly case, deviation (residual error) time-series trajectory data before the occurrence of the anomaly case is stored into a database, and the similarity between the deviation (residual error) time-series pattern of the observed data and the time-series pattern of the trajectory data accumulated in the trajectory database is calculated, so that a sign of the occurrence of the anomaly can be detected.

If such a trajectory is displayed for a user on a GUI (Graphical User Interface), the conditions of the occurrence of anomalies can be visually expressed and can be easily reflected on the countermeasures.

If only the comprehensive residual error is tracked while ignoring the temporal circumstances, it is difficult to recognize the anomaly phenomenon. However, the temporal circumstances of the residual vectors can be tracked, the phenomenon can be recognized quite clearly. In theory, if the vectors of events of a composite event are added to each other, it can be understood that a sign of the occurrence of anomalies of the composite event can be detected, and the residual vectors can accurately express the anomalies. If the trajectories of the past anomaly cases A and B are stored in the database as known trajectories, the type of anomaly can be specified (diagnosed) by checking against these trajectories.

Further, if FIG. 13 is viewed as the occurrence of the residual vectors in a certain time window, the occurrence can be expressed as frequency. If the occurrence can be handled as frequency, the frequency distribution information in a format shown in FIG. 7A can be obtained, and the information can be handled as the frequency of appearance of the keyword of the phenomenon. Specifically, the information can be used for diagnoses. In order to handle the residual vectors of FIG. 13 as frequency, each axis of FIG. 13 is sectioned into certain widths, and the frequency distribution can be generated based on whether to be within the section of each cube. In the case shown in FIG. 13 is three-dimensional, and in general, multidimensional frequency distribution is generated. However, one-dimensional (vectorized) frequency distribution can be realized by vertically arranging, and can be handled as general frequency distribution and frequency patterns.

FIG. 14 shows a hardware configuration of the system for anomaly detection/diagnosis 100 of the present invention. The system includes a processor 120, a database 121, a display unit 122, and an input unit 123. The sensor data 104 of a targeted engine is input to the processor 120 for detecting anomalies, and is stored into the database DB121 after a missing value is restored. The processor 120 detects anomalies using the obtained observed sensor data 104 and DB data of the database DB121 composed of learning data. Various kinds of information are displayed by the display unit 122, and the presence or absence of anomaly signals is output. A trend can be displayed. An interpretation result of an event can be displayed. Further, the processor 120 accesses the database DB121 in which the maintenance record information and the like are stored to extract and search for a keyword, and a diagnosis model is generated, so that an anomaly diagnosis is executed and the result of the diagnosis is displayed on the display unit 122.

The result of the diagnosis includes the diagnosis model shown in FIG. 4B. Specifically, the result of the phenomenon diagnosis, the result of the phenomenon classification, the diagnosis model, and the like are displayed. Further, various pieces of information shown in FIG. 5, FIG. 6, FIG. 7A, and FIG. 7B are displayed. Especially, the frequency histogram shown in FIG. 7B is an important display factor for visualizing the frequency patterns of FIG. 7A. A part of the frequency histogram is selected and displayed as “context” representing the conditions of the machinery, the conditions of the occurrence of anomalies, the conditions of maintenance, the background resulting in part replacement, past cases, and the like. These can be edited in the viewpoint of merging of items.

Other than the hardware, a program installed in the hardware can be provided to customers through media or on-line services.

The DB of the database DB121 can be operated by skilled engineers. Especially, the DB can teach and store anomaly cases and cases of countermeasures. (1) Learning data (normal), (2) anomaly data, and (3) content of countermeasures are stored. Since the database DB121 is structured so that skilled engineers can edit, a sophisticated and useful database can be completed. Further, data is operated by automatically moving the learning data (each data and the position of the center of gravity) along with the occurrence of an alarm and part replacement. Further, the obtained data can be automatically added. If there is anomaly data, a method of general vector quantization can be applied when data is moved.

Further, the trajectories of the past anomaly cases A and B described in FIG. 13 are stored in the database DB121, and the type of anomaly is specified (diagnosed) by checking against these trajectories. In this case, the trajectories are expressed and stored as data in an N-dimensional space. Data is processed by the processor 120 through the input unit 123. In addition, data to be displayed on the display unit 122 is instructed through the input unit 123.

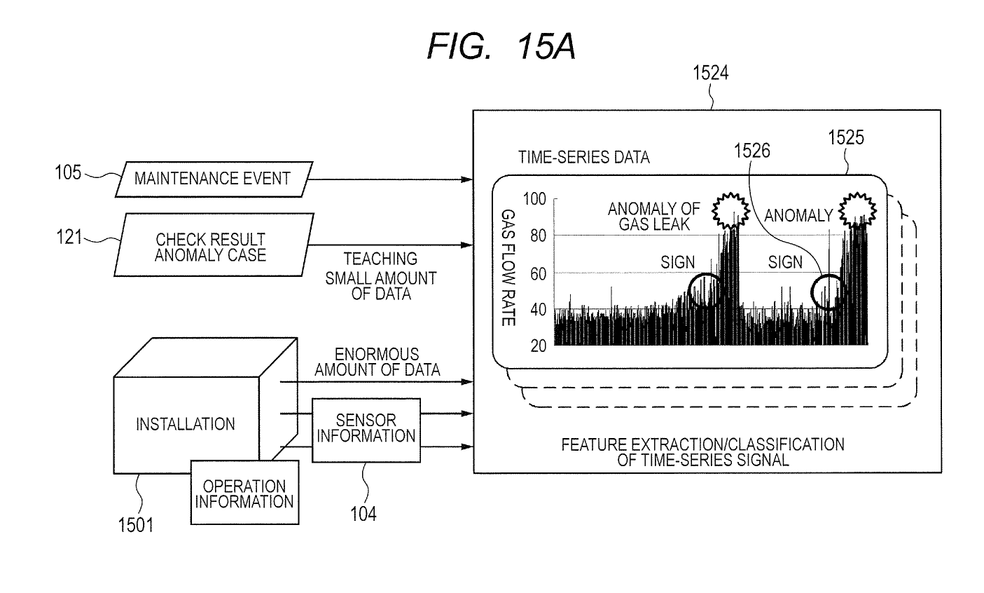

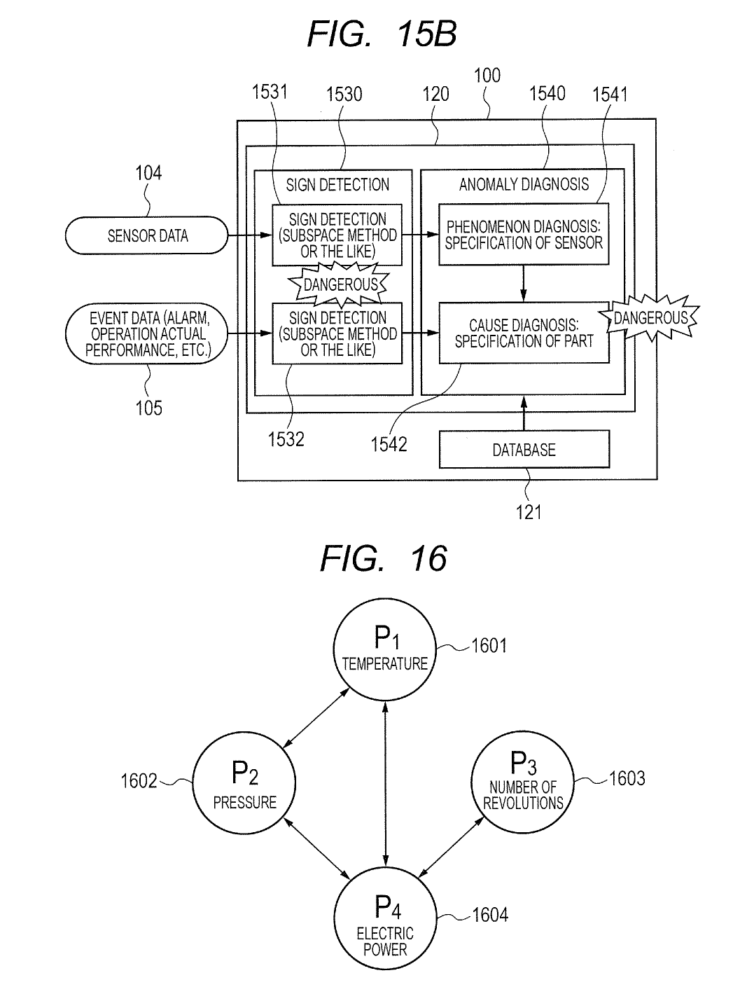

FIG. 15A and FIG. 15B show anomaly detection and a diagnosis after the anomaly detection. In FIG. 15A, the time-series signal (sensor signal) 104 of the machinery 1501 transmitted from the time-series data obtaining unit 103 is processed in the inside of the processor 120 to is perform feature extraction/classification 1524 of the time-series signal, so that anomalies are detected. The number of machineries 1501 is not limited to one. Plural machineries may be targeted. At the same time, additional information such as the event 105 (an alarm, operation actual performance, and the like such as start and breakdown of the machinery settings of operation conditions, various breakdown information, various alarm information, regular check information, operation environments such as setting temperatures, operation accumulated time, part replacement information, adjustment information, and cleaning information) of maintenance of each machinery is obtained to detect anomalies with high sensitivity.

A waveform 1525 of the time-series data shown in the feature extraction/classification 1524 of the time-series signal 104 in FIG. 15A represents an observed signal, and the anomalies detected in the embodiment are shown as signs represented by circles 1526. The signs are detected because the anomaly measurement reaches a predetermined threshold value or larger (or if the anomaly measurement exceeds the threshold value by the set number of times or larger), and it is determined as an anomaly. In the example, signs of anomalies can be detected and countermeasures can be appropriately taken before the machinery is breakdown.

As shown in FIG. 15B, if an anomaly can be quickly detected as a sign by a sign detecting unit 1530 of the processor 120 of the system for anomaly detection/diagnosis 100, some countermeasures can be taken before the machinery is broken and the operation is halted. Further, a sign is detected by the subspace method (1531), it is comprehensively determined whether or not the sign is a sign of an anomaly while additionally performing event row checking (1532), an anomaly diagnosis is executed by an anomaly diagnosing unit 1540 using the method shown in FIG. 4A on the basis of the sign, a breakdown part candidate is specified, and it is estimated when the part causes a machinery breakdown. Then, necessary parts are arranged at necessary timing.

The anomaly diagnosing unit 1540 can be easily understood by being divided into a phenomenon diagnosing unit 1541 that specifies a sensor with a sign and a cause diagnosing unit 1542 that specifies a part that possibly causes breakdown. The sign detecting unit 1530 outputs information related to the feature amounts as well as a signal indicating the presence or absence of an anomaly to the anomaly diagnosing unit 1540. On the basis of the information, the anomaly diagnosing unit 1540 allows the phenomenon diagnosing unit 1541 to execute a phenomenon diagnosis using information stored in the database 121. Further, the phenomenon diagnosing unit 1541 classifies the phenomenon. On the basis of the method shown in FIG. 4A, the cause of such a phenomenon is diagnosed in the cause diagnosing unit 1542 by specifying an adjustment part and a part to be replaced using the information stored in the database 121.

FIG. 16 shows an example of generating a network of each sensor signal using information of the influence rate to the anomaly of each obtained sensor signal. Weight can be applied to the sensor signals of a basic temperature 1601, a pressure 1602, the number of revolutions 1603 of a motor, and electric power 1604 on the basis of the ratio of the influence rate to the anomaly. These relations can be used in the diagnosis model of FIG. 4A as keywords.

If such a relevant network is established, compatibility, co-occurrence, and correlation between signals that are not intended by a designer can be clearly specified, and the network is useful in the anomaly diagnosis. The network can be generated in the viewpoints of correlation, similarity, a distance, a causal connection, and advance/delay of a phase, in addition to the influence rate to the anomaly of each sensor signal.

### <Model of Target Machinery; Network of Selected Sensor Signal>

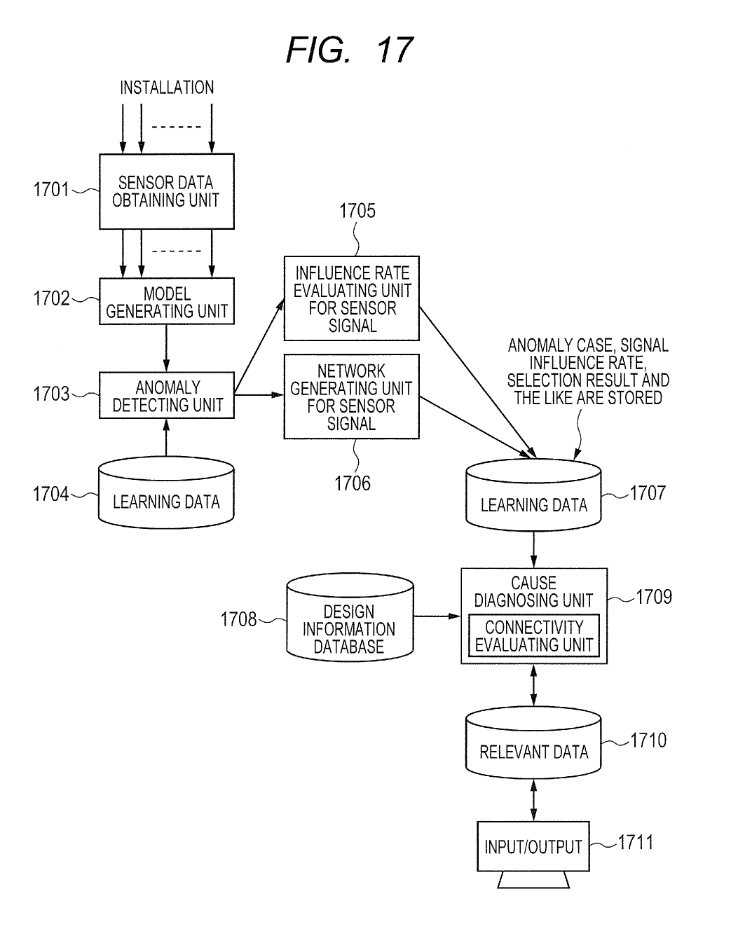

FIG. 17 shows a configuration related to anomaly detection/cause diagnosis. In FIG. 17, provided are a sensor data obtaining unit 1701 (corresponding to the time-series data obtaining unit 103 of FIG. 1) that obtains data from plural sensors, learning data 1704 mainly composed of normal data, a model generating unit 1702 that models the learning data, an anomaly detecting unit 1703 that detects the presence or absence of an anomaly of the observed data on the basis of similarity between the observed data and the modeled learning data, an influence rate evaluating unit 1705 of a sensor signal that evaluates the influence rate of each signal, a sensor signal network generating unit 1706 that generates a network diagram showing a correlation between the sensor signals, a relevant database 1707 composed of anomaly cases, the influence rate of each sensor signal and selection results, a design information database 1708 composed of design information of the machinery, a cause diagnosing unit 1709, a relevant database 1710 that stores diagnosis results, and an input/output unit 1711. The keywords obtained through these processes are utilized in the diagnosis model of FIG. 4A. In other words, these processes can be regarded as a keyword generating unit.

The design information database contains information other than the design information. As an example of an engine, the design information database contains a model year, a model, a bill of materials (BOM), past maintenance information (content of on-call, sensor signal data at the time of occurrence of anomalies, adjustment date and time, captured image data, abnormal noise information, replacement part information, and the like), operation status information, inspection data at the time of transportation/machinery, and the like.

### INDUSTRIAL APPLICABILITY

The present invention can be used in anomaly detection for a plant or machinery.

### REFERENCE SINGS LIST

100 . . . system for anomaly detection/diagnosis
103 . . . multidimensional time-series signal obtaining unit
120 . . . processor
121 . . . database unit
122 . . . display unit
123 . . . input unit

1. A method for anomaly detection/diagnosis that detects an anomaly of a plant or machinery, or a sign of an anomaly to diagnose the plant or the machinery, the method comprising the steps of:
detecting an anomaly of the plant or the machinery by using data obtained from plural sensors;
extracting a keyword from maintenance record information of the plant or the machinery;
generating a diagnosis model of the plant or the machinery by using the extracted keyword; and
diagnosing the plant or the machinery by using the generated diagnosis model.

2. The method for anomaly detection/diagnosis according to claim 1,
Wherein in the step of extracting, the maintenance record information includes any of on-call data, an operational report, an adjustment/replacement part code, image information, and sound information;
wherein in the step of generating, the frequency of appearance of the keyword set on the basis of the maintenance record information is calculated to obtain the pattern of the frequency of appearance, and
wherein in the step of diagnosing, the obtained pattern of the frequency of appearance is used as the diagnosis model, and the plant or the machinery is diagnosed using similarity between the pattern of the frequency of appearance of the diagnosis model and a keyword related to a newly-detected anomaly of the plant or the machinery.

3. The method for anomaly detection/diagnosis according to claim 1,
wherein in the step of extracting, a phenomenon diagnosis is made or a phenomenon is classified to express a relation between the sensors using the data obtained from the plural sensors, the frequency of appearance of a keyword that appears as a result is calculated, and
wherein in the step of diagnosing, similarity between the calculated frequency of appearance of the keyword and the pattern of the frequency of appearance of the keyword in the diagnosis model is calculated, and the plant or the machinery is diagnosed using the calculated similarity.

4. The method for anomaly detection/diagnosis according to claim 1,
wherein in the step of detecting, data is obtained from the plural sensors;
wherein in the step of generating, learning data mainly composed of normal data is modeled; and
wherein in the step of diagnosing, the anomaly measurement of the obtained data is calculated as a vector using the modeled learning data, and an anomaly is detected on the basis of the trajectory of the vector of the anomaly measurement over time.

5. A system for anomaly detection/diagnosis that detects an anomaly of a plant or machinery, or a sign of an anomaly to diagnose the plant or the machinery, the system comprising:
an anomaly detecting unit that detects an anomaly of the plant or the machinery using data obtained from plural sensors;
a database unit that accumulates maintenance record information of the plant or the machinery;
a diagnosis model generating unit that generates a diagnosis model of the plant or the machinery using a keyword extracted from the maintenance record information of the plant or the machinery accumulated in the database unit; and
a diagnosing unit that diagnoses the plant or the machinery by checking a newly-detected anomaly against the diagnosis model.

6. The system for anomaly detection/diagnosis according to claim 5,
wherein the database unit accumulates the maintenance record information including any of on-call data, an operational report, an adjustment/replacement part code, image information, and sound information;
wherein the diagnosis model generating unit calculates the frequency of appearance of the keyword set on the basis of the maintenance record information to obtain the pattern of the frequency of appearance, and uses the same as the diagnosis model; and
wherein the diagnosing unit diagnoses the machinery using similarity of the pattern of the frequency of appearance for a newly-detected anomaly.

7. The system for anomaly detection/diagnosis according to claim 5, further comprising:
a phenomenon diagnosing unit that expresses a relation between the sensors using the data obtained from the plural sensors or classifies a phenomenon;
wherein the diagnosing unit calculates the frequency of appearance of a keyword that appears through the phenomenon diagnosing unit to calculate similarity with the pattern of the frequency of appearance; and the plant or the machinery is diagnosed using the calculated similarity.

8. The system for anomaly detection/diagnosis according to claim 5,
wherein the diagnosis model generating unit obtains data from the plural sensors to model learning data mainly composed of normal data; and
wherein the diagnosing unit calculates the anomaly measurement of the obtained data as a vector using the modeled learning data, and detects an anomaly on the basis of the trajectory of the vector of the anomaly measurement over time.

9. A program for anomaly detection/diagnosis that quickly detects an anomaly of a plant or machinery, or a sign of an anomaly to make a diagnosis, the program comprising:
a processing step of detecting an anomaly using data obtained from plural sensors;
a processing step of generating a diagnosis model using the frequency of appearance of a keyword obtained from maintenance record information; and
a diagnosis processing step of diagnosing the plant or the machinery using the diagnosis model generated in the processing step of generating the diagnosis model.

10. The program for anomaly detection/diagnosis according to claim 9,
wherein in the processing step of detecting the anomaly, an anomaly is detected using the data obtained from the plural sensors;
wherein in the processing step of generating the diagnosis model, the diagnosis model is generated using the frequency of appearance of the keyword obtained from the maintenance record information; and
wherein in the step of diagnosis processing step, a pattern or a keyword is extracted through anomaly detection or a phenomenon diagnosis when the machinery is diagnosed using the diagnosis model generated in the diagnosis processing step, and the extracted pattern or keyword is used for a diagnosis.

11. A system for corporate asset management/machinery asset management comprising:
a database that stores maintenance record information composed of an operational report, replacement part information, and the like;
detecting means that allows a classifier such as a subspace method to detect an anomaly or a sign of an anomaly using signal information obtained from a multidimensional sensor attached to the machinery; and
diagnosing means that makes a diagnosis on the basis of the frequency pattern of a keyword focusing on a replacement part or an adjustment, wherein
the system performs anomaly/sign detection and a diagnosis triggered by the anomaly/sign detection.

12. The system for corporate asset management/machinery asset management according to claim 11, further including phenomenon classifying means which classify the detected anomaly or sign into phenomena.

13. The system for corporate asset management/machinery asset management according to claim 12, wherein the phenomenon classifying means that classifies the detected anomaly or sign into phenomena can edit the phenomena.

14. The system for corporate asset management/machinery asset management according to claim 11, wherein the phenomenon classifying means edit each item of the frequency pattern of the keyword.

15. The system for corporate asset management/machinery asset management according to claim 11, further comprising a display which displays the frequency pattern of the keyword and the displayed keywords can be edited as context of the machinery and a maintenance operation.

16. The system for corporate asset management/machinery asset management according to claim 11, wherein the diagnosing means groups each item of the frequency pattern of the keyword or selects them by time.

17. The system for corporate asset management/machinery asset management according to claim 11, wherein in the diagnosing means, the keyword is a word, a symbol, or a code set in the system, or a symbol output in a process of anomaly detection or the like.

18. The system for corporate asset management/machinery asset management according to claim 11, wherein in the diagnosing means, the frequency of appearance of the keyword is recorded as a pattern, and the maintenance record information can be reused by utilizing the pattern.
